(19) United States
(12) Patent Application Publication
(10) Pub. No.: US 2008/0138131 A1
(43) Pub. Date: Jun. 12, 2008

(54) FUSING DEVICE AND IMAGE FORMING APPARATUS COMPRISING THE SAME

(75) Inventors: Chang Hoon JUNG, Seoul (KR); Tae-Gyu KIM, Hwaseong-si (KR); Hwan Guem KIM, Seoul (KR); Su Ho SHIN, Seongnam-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/927,758

(22) Filed: Oct. 30, 2007

(30) Foreign Application Priority Data
Dec. 6, 2006 (KR) 2006-123342

(51) Int. Cl. G03G 15/20

(52) U.S. Cl. 399/329

(57) ABSTRACT

A fusing device and an image forming apparatus including the fusing device fuses a toner image formed on a printing paper. The fusing device includes a pressure roller which axially rotates, a fusing belt which forms a nip portion with the pressure roller where a printing paper is nipped, and which rotates by a rotational force transmitted from the pressure roller, a heater supplied with a power source to generate heat and to transmit at least a portion of the generated heat to the nip portion, and a phase changing portion which includes a material having a phase varying in a heating temperature range of the heater, accumulates latent heat from heat of the heater, and provides the nip portion with the accumulated latent heat.

### CROSS-REFERENCE TO RELATED APPLICATIONS

This application claims the benefit of Korean Patent Application No. 10-2006-0123342, filed on Dec. 6, 2006, in the Korean Intellectual Property Office, the disclosure of which is incorporated herein by reference.

### BACKGROUND OF THE INVENTION

1. Field of the Invention

The present general inventive concept relates to a fusing device and an image forming apparatus including the fusing device, and more particularly, to a fusing device and an image forming apparatus including the fusing device, which can improve a structure, reduce a period of time required to print a first page, and also minimize a temperature change due to printing paper supply, thereby improving a printing quality, and easily controlling a fusing temperature.

2. Description of the Related Art

FIG. 1 illustrates a configuration of a general image forming apparatus.

Referring to FIG. 1, the image forming apparatus of an electrophotograph method generally has sequential operations, such as charging, scanning, developing, transferring, and fusing, and forms an image on a printing paper P.

First, positive (+) and negative (−) electric charges are formed inside and outside of a surface of a drum 30 according to high-voltage corona discharge of a charging device 20. Also, the surface of the drum 30 on which the electric charges are formed rotates, and a laser beam is scanned according to a signal of each scanning pattern unit in an optical system. Also, the (−) electric charge formed on the surface of the drum 30 is removed into a letter form, and a latent image is formed.

Next, when a magnetic roller 40 and the drum 30 of a developing device rotate adjacent to each other at minute intervals, toner particles having a (−) component adhere to the surface of the drum 30 on which the laser beam is scanned, to form the letter on the surface.

Here, the laser beam from a light source 12 is generally modulated by laser beam modulation operated by signal processing, and is generally scanned by a laser beam collimator (not illustrated). Also, tremor and distortion of the scanned laser beam are corrected when the scanned laser beam passes through lenses 16 for correction after being scanned on a polygon mirror 14, and a phase is formed on the surface of the drum 30 via a reflecting mirror 18.

A transferring device 80 forms the (+) electric charge on a back surface of the printing paper according to high-voltage corona discharge, thereby drawing (−) toner particles formed on the surface of the drum 30 to form the image on the printing paper P.

Next, the printing paper P is outputted after a fusing device 50 applies appropriate heat and pressure to the toner image formed on the printing paper P, and fuses the toner particles to the printing paper P.

Also, residual toner remaining on the surface of the drum 30 passes through a cleaning portion 70, is removed from the drum 30, and is transmitted to a waste toner box. Also, residual electric charge remaining on the surface of the drum 30 is neutralized by regular light, returns to an initial state, and is enabled to be charged by the charging device 20 again.

The fusing device 50, which fuses the toner image formed on the printing paper P of the image forming apparatus, may be generally classified into a roller method and a belt method depending on a fusing method.

FIG. 2 illustrates a configuration of the fusing device 50 in a roller method of the image forming apparatus of FIG. 1.

The fusing device 50 in the roller method basically includes a pressure roller 52 which rotates with respect to an axial rotation axis, a fusing roller 54 which rotates with the pressure roller 52, and forms a nip portion N where a printing paper P is nipped or passes through the nip N between the pressure roller 52 and the fusing roller 54. A heater 56 is provided in a central portion of the fusing roller 54, and transmits heat to the fusing roller 54.

The printing paper P is supplied between the pressure roller 52 and the fusing roller 54, and a toner image T is fused by pressure between the pressure roller 52 and the fusing roller 54, and also fused by surface heat of the fusing roller 54 heated by the heater 56.

However, since it is required that the fusing device 50 in the roller method should heat an entire outer circumferential surface of the fusing roller 54 with heat from the heater 56, a relatively long period of time for heating the fusing roller 54 is required. Specifically, the fusing device 50 in the roller method has a problem that a relatively long period of time of initial preheating is required due to a large heat capacity of the fusing roller 54.

In order to overcome the above-described problem, a device in a belt method is proposed.

Referring to FIG. 3, a configuration of a fusing device in a belt method is described.

A fusing device 60 in the belt method generally includes a pressure roller 62 which rotates with respect to a longitudinal rotation axis, a fusing belt 64 which rotates with a printing paper P by a rotational force transmitted from the pressure roller 62, and a heater 66 is supplied with a power source to generate heat. Also, the fusing device 60 in the belt method includes a protector 65 which protects a front surface of the heater 66, and a supporter 68 provided on an outer surface of the heater 66. The fusing device 60 includes a rotation guiding portion 69 which guides a rotation of the fusing belt 64.

Specifically, the fusing belt 64 of the fusing device 60 in the belt method rotates with the printing paper P, however, the heater 66 provided inside of the fusing belt 64 is fixed, transmits heat to a nip portion N where the printing paper P is nipped, and performs fusing of a toner image T.

Accordingly, since heat is not transmitted to an entire outer circumferential surface of the fusing belt 64, and heat is locally transmitted to the only nip portion N, a period of time of initial preheating may be significantly reduced. Specifically, since a heat capacity of either the protector 65, or the fusing belt 64 is small, a temperature of the nip portion N may rise relatively quickly, thereby reducing a period of time of initial preheating, and reducing a period of time required for printing.

The fusing device 60 in the belt method having the above structure has an advantage of reducing a period of time of initial preheating as local heating method, compared to the fusing device 50 in the roller method of FIG. 2, however, there is a problem that a temperature drops due to printing paper supply since the fusing device 60 in the belt method has a small heat capacity.

Specifically, since a temperature of the nip portion drops due to the supply of the printing paper having a relatively low temperature, there is a temperature difference during an initial period and a later period of printing, and there is a difference in the degree of fusing. Accordingly, there is a problem that a printing quality difference occurs since there is a fusing degree difference between an upper portion and a lower portion of the printing paper P.

Also, there is a problem that a printing quality is uneven since a temperature of a heater is overheated to be higher than an optimum temperature. Also, there is a problem that a power source which is supplied for the heater is required to accurately control the temperature of the heater.

### SUMMARY OF THE INVENTION

The present general inventive concept provides a fusing device and an image forming apparatus including the fusing device, which can improve a structure, reduce a period of time required when printing a first page, and also minimize a temperature change due to printing paper supply, thereby improving a printing quality, and easily controlling a fusing temperature, are required.

The present general inventive concept also provides a fusing device and an image forming apparatus including the fusing device, which can reduce a period of time of initial preheating, and minimize a temperature change due to printing paper supply.

The present general inventive concept also provides a fusing device and an image forming apparatus including the fusing device, which can provide an even level of fusing degree on a printing paper regardless of changes of printing loads, and obtain a constant printing quality.

The present general inventive concept also provides a fusing device and an image forming apparatus including the fusing device, which can control a temperature of a heater to be an optimum temperature range, and optimally maintain a fusing temperature of the fusing device.

Additional aspects and utilities of the present general inventive concept will be set forth in part in the description which follows and, in part, will be obvious from the description, or may be learned by practice of the general inventive concept

The foregoing and/or other aspects and utilities of the present general inventive concept may be achieved by providing a fusing device of an image forming apparatus which fuses a toner image which is formed on a printing paper, the fusing device including a pressure roller which axially rotates, a fusing belt which forms a nip portion with the pressure roller where a printing paper is nipped, and which rotates by a rotational force transmitted from the pressure roller, a heater supplied with a power source to generate heat and to transmit at least a portion of the generated heat to the nip portion, and a phase changing portion which comprises a material having a phase varying according to a heating temperature range of the heater, to accumulate latent heat from the heat of the heater, and to provide the nip portion with the accumulated latent heat.

The phase changing portion may adjoin the heater, and the phase changing portion may be provided on at least one surface of a front surface and a rear surface of the heater.

The phase changing portion may change the phase between a solid phase and a liquid phase. A melting point of the phase changing portion may be equal to or higher than a fusing temperature of the nip portion.

The material of the phase changing portion may be formed by mixing a plurality of materials having different melting points. In this case, a melting point of the phase changing portion may be controlled by changing a composition ratio of the plurality of materials.

The phase changing portion may include at least one material of lead (Pb) and tin (Sn).

The phase changing portion may be provided covering an entire surface of a width direction and a progressive direction of the printing paper, and may be disposed in receiving grooves which are disposed at predetermined intervals according to either a width direction or a progressive direction of the printing paper.

The fusing device may further include a supporter which covers an outside of the heater and the phase changing portion, and a nip former which is provided between the heater and an inner circumferential surface of the fusing belt and forms the nip portion on the fusing belt.

The foregoing and/or other aspects and utilities of the present general inventive concept may also be achieved by providing an image forming apparatus including a fusing device having a pressure roller which axially rotates, a fusing belt which forms a nip portion with the pressure roller where a printing paper is nipped, and which rotates by a rotational force transmitted from the pressure roller, a heater supplied with a power source to generate heat and to transmit at least a portion of the generated heat to the nip portion, and a phase changing portion which comprises a material having a phase varying according to a heating temperature range of the heater, to accumulate latent heat from the heat of the heater, and to provide the nip portion with the accumulated latent heat.

The foregoing and/or other aspects and utilities of the present general inventive concept may also be achieved by providing a fusing device usable in an image forming apparatus which fuses a toner image formed on a printing paper, the fusing device including a pressure roller, a fusing element to form a nip portion with the pressure roller, and a heater to generate heat, and to transmit the generate heat to the nip portion, and a phase changing portion disposed adjacent to the heater to store a portion of the heat as latent heat, and to transmit the latent heat toward the nip portion.

The phase changing portion may include a second heater to generate the stored portion of the heat as a second heat.

The phase changing portion may include a material having a variable phase.

The phase changing portion may include a phase varying according to a temperature of the heater.

The phase changing portion may include a phase variable according to a temperature of the heat transmitted from the heater.

The phase changing portion may include a plurality of phase changing portions disposed around the heater.

The plurality of phase changing portions may be disposed in a direction parallel to a rotation axis of the fusing element.

The plurality of phase changing portions may be disposed in a direction corresponding to a rotation direction of the fusing element.

The plurality of phase changing portions may be spaced-apart from each other.

The phase changing portion may include a first phase changing portion having a firs material having a first characteristic phase and a second phase changing portion having a second material having a second characteristic phase.

The first characteristic phase may change according to a first temperature of the heater, and the second characteristic phase may change according to a second temperature of the heater.

The phase changing portion may be disposed in a direction parallel to a rotation axis of one of the fusing element and pressure roller.

The phase changing portion directly contacts the heater to receive the heat.

The foregoing and/or other aspects and utilities of the present general inventive concept may also be achieved by providing a fusing device usable in an image forming apparatus which fuses a toner image formed on a printing paper, the fusing device including a pressure roller, a fusing element to form a nip portion with the pressure roller, a heater to generate heat and to transmit the generate heat to the nip portion, and a phase changing portion having a capacity greater than that of the pressure roller and the fusing element to store a portion of the heat as latent heat, and to transmit the latent heat toward the nip portion.

### BRIEF DESCRIPTION OF THE DRAWINGS

The above and/or other aspects and utilities of the present general inventive concept will become apparent and more readily appreciated from the following detailed description, taken in conjunction with the accompanying drawings of which:

FIG. 1 is a configuration diagram illustrating a conventional image forming apparatus in a general electrophotograph method;

FIG. 2 is a sectional view illustrating a conventional fusing device in a roller method of the image forming apparatus of FIG. 1;

FIG. 3 is a sectional view illustrating a conventional fusing device in a belt method of the image forming apparatus of FIG. 1;

FIG. 4 is a sectional view illustrating a fusing device of an image forming apparatus according to an exemplary embodiment of the present general inventive concept;

FIGS. 5A and 5B are graphs illustrating temperature changes of nip portions of a fusing device over a period of time during a preheating process and a fusing process;

FIGS. 6A and 6B are sectional views illustrating phase changing portions formed in different locations of a fusing device according to an exemplary embodiment of the present general inventive concept; and

FIGS. 7A through 7C are sectional views illustrating phase changing portions with different dispositions and forms according to an exemplary embodiment of the present general inventive concept.

### DETAILED DESCRIPTION OF THE PREFERRED EMBODIMENTS

Reference will now be made in detail to exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

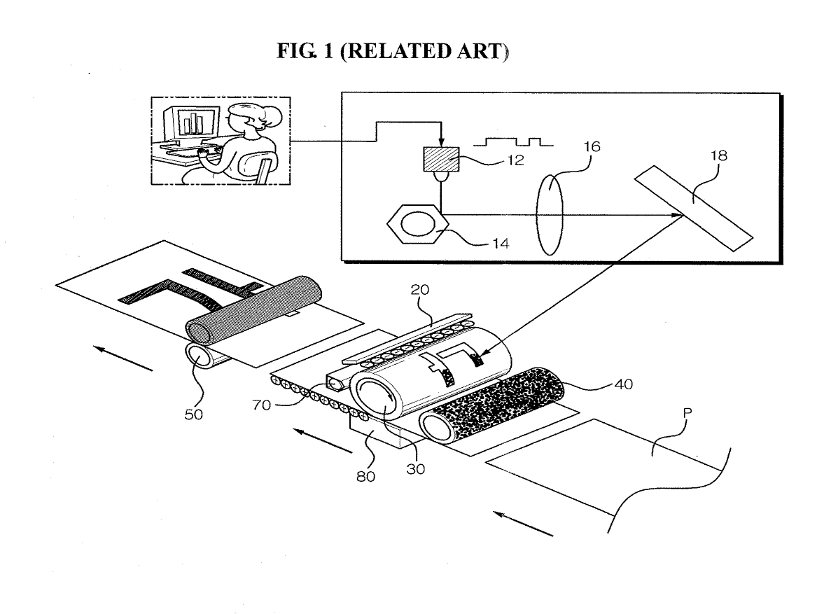

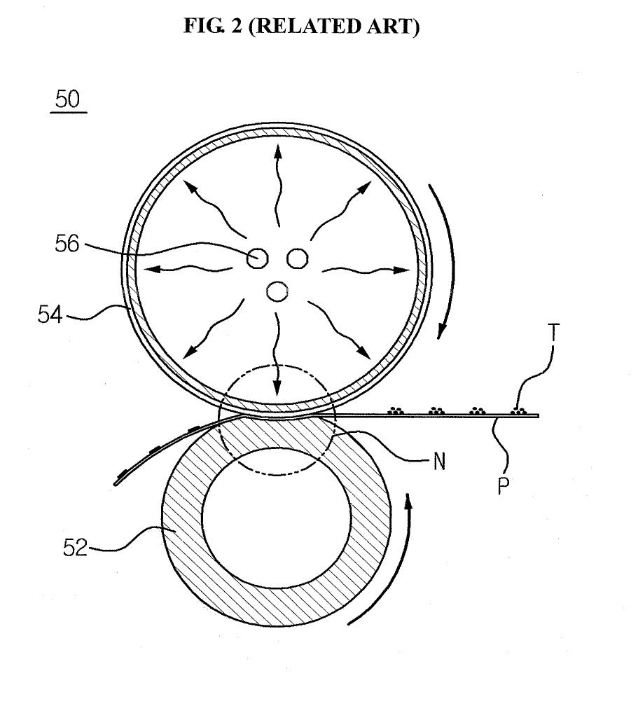

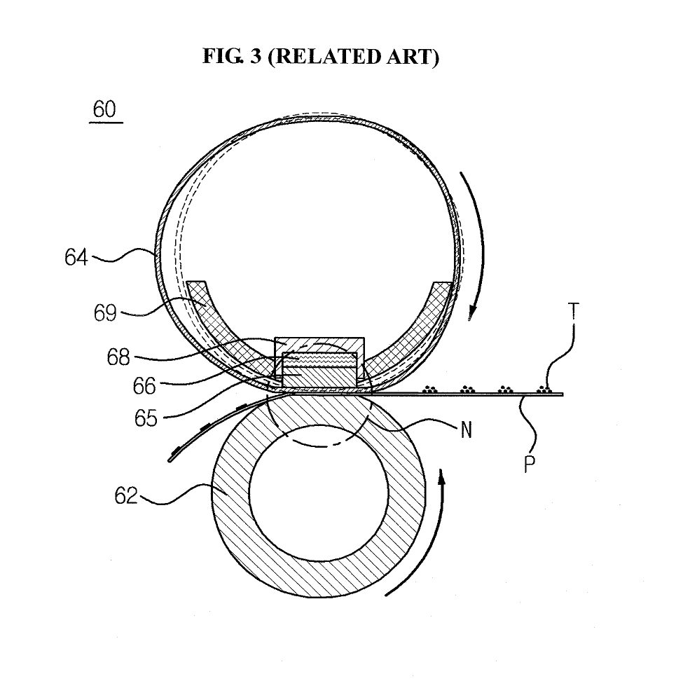

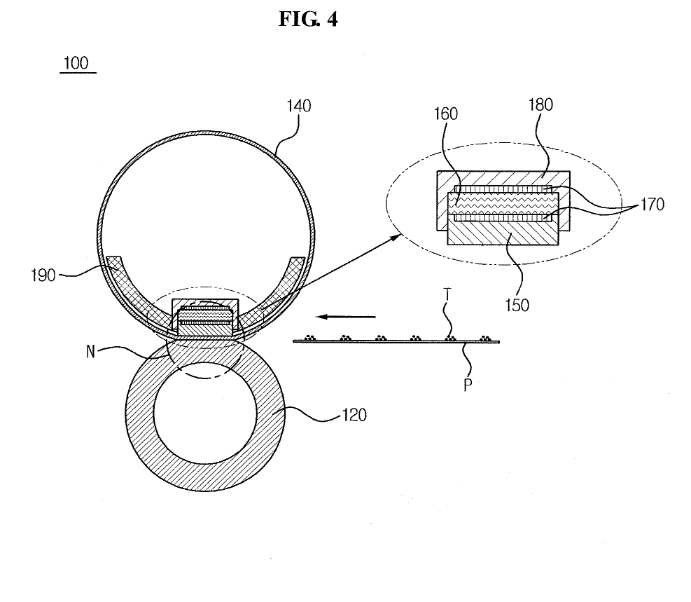

FIG. 4 illustrates a configuration of a fusing device 100 usable in an image forming apparatus according to an exemplary embodiment of the present general inventive concept. The image forming apparatus may have a paper feeding unit, a printing unit, and a paper discharging unit. The printing unit may include the fusing device 100 of FIG. 4. Components of the image forming apparatus may be similar to components of a conventional image forming apparatus of FIG. 1 except the fusing device 100 of FIG. 4, and thus detailed descriptions thereof will be omitted.

The fusing device 100 fuses a toner image T on a printing medium in an image forming apparatus by appropriate pressure and temperature. The fusing device 100 according to the present exemplary embodiment may a pressure roller 120, a fusing belt 140, a heater 160, a phase changing portion 170, and a rotation guide plate 190 to guide the fusing belt 140.

The pressure roller 120 is supplied with a driving force to rotate with respect to a longitudinal rotation axis. Also, the pressure roller 120 is generally shaped in a cylinder form which is formed longer in a length direction. The present exemplary embodiment illustrates an exemplary embodiment shaped in a cylinder form in which a specific portion of an inside of the pressure roller 120 is hollow, as illustrated in FIG. 4. However, the present general inventive concept is not limited thereto.

The fusing belt 140 corresponds to a component to form a nip portion N with the pressure roller 120, and is configured to rotate to feed the printing paper by a rotational force transmitted from the pressure roller 120. Also, the fusing belt 140 is configured in a belt form which is formed longer in a length direction corresponding to the pressure roller 120.

Here, the nip portion N indicates a portion in which the pressure roller 120 and the fusing belt 140 are in contact with each other, and the printing paper P is nipped or passes therethrough.

The fusing belt 140 generally has a regular elastic force for a smooth rotation. Also, heat generated from the heater 160 is transmitted to the fusing belt 140, and the fusing belt 140 fuses the toner image T formed on the printing paper P supplied to the nip portion N.

A compression force is required to fuse toner particle to the printing paper P and is maintained constant between the fusing belt 140 and the pressure roller 120.

The heater 160 generates heat, is supplied with a power source, and transmits at least a portion of the generated heat to the printing paper P disposed in the nip portion N. Here, a method of generating heat in the heater 160 may be variously realized using an electro thermal wire, a lamp, and the like.

Here, a nip former 150 is provided on an entire surface of the heater 160 to face the nip portion N, for example, the nip former 150 is provided between the heater 160 and an inner circumferential surface of the fusing belt 140, forms the nip portion N between the pressure roller 120 and the fusing belt 140 where the printing paper is nipped, and protects the heater 160.

Also, the nip former 150 transmits heat generated in the heater 160 to the nip portion N of the fusing belt 140.

The phase changing portion 170 may be a component which includes a material having a phase variable according to a heating temperature range of the heater 160, accumulates latent heat from heat of the heater 160, and provides the nip portion N with the accumulated latent heat.

In the present exemplary embodiment, the phase changing portion 170 adjoins the heater 160, and heat from the heater 160 is transmitted to the phase changing portion 170 by conduction, for example.

The present exemplary embodiment illustrates two phase changing portions 170 respectively disposed on a front surface and a rear surface of the heater 160. However, the present general inventive concept is not limited thereto. A single phase portion can be formed a portion of the heater 160. It is possible that three or more phase changing portions can be formed three or more portions of the heater 160.

A phase of the phase changing portion 170 may change either between a solid phase and a liquid phase, or between a liquid phase and a vapor phase. The present exemplary embodiment illustrates a form in which the phase is changed between a solid phase and a liquid phase to easily perform packaging due to relatively little volume change. However, the present general inventive concept is not limited thereto. The material of the phase changing portion 170 may be a material having at least two different phases.

The phase changing portion 170 may have a melting point in a heating temperature range of the heater 160.

A fusing temperature of the nip portion N may be slightly lower than a temperature of the heater 160 due to heat loss during transmitting of heat. Although temperatures are different depending upon operation environments, a temperature of the heater 160 corresponds to about 230° C. to about 240° C., and a temperature of the nip portion N corresponds to about 180° C. to about 200° C. according to analysis of numerical values in the present exemplary embodiment.

Since the phase changing portion 170 adjoins the heater 160, it is possible that a melting point of the phase changing portion 170 may be higher than or equal to a fusing temperature of the nip portion N.

For example, a material of the phase changing portion 170 can satisfy the above condition and may include either tin (Sn) in which a melting point corresponds to about 232° C., or an alloy including lead (Pb) and Sn in which a melting point corresponds to about 183° C.

For example, a melting point of Pb corresponds to about 327° C., and a melting point of Sn corresponds to about 232° C. However, a melting point of the mixed alloy of two elements becomes lower than melting points of the two respective elements due to an eutectic reaction. Specifically, when mixing Pb and Sn at a ratio of about 63 to 37, the melting point of the mixed alloy corresponds to about 183° C.

As described above, the material of the phase changing portion 170 may be formed by mixing a plurality of materials having different melting points, and a melting point of the phase changing portion 170 may be controlled by changing a composition ratio of the plurality of materials in this case.

The present exemplary embodiment includes a supporter 180 which covers an outside of the heater 160 and the phase changing portion 170, and the supporter 180 accommodates the heater 160 and the phase changing portion 170.

At least a portion of the supporter 180 includes a heat insulating member preventing the phase changing portion 170 from radiating heat in order to minimize radiation of heat.

Also, the fusing belt 140 includes polyimide (PI), and the nip former 150 includes a material for wear-resistance and lubrication. Also, since the nip former 150 is significantly thin, compared with the heater 160 or the phase changing portion 170, a heat capacity is significantly small. The supporter 180 is disposed to support the heater and the phase changing portion 170 with respect to the rotation guiding portion 190.

The rotation guiding portion 190 is disposed both sides of the heater unit 110 to guide a rotation of the fusing belt 140.

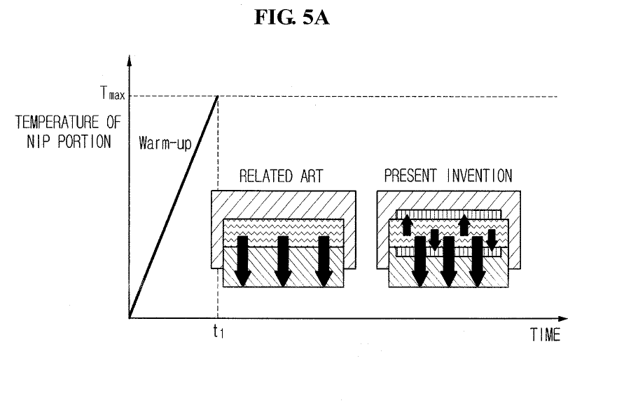

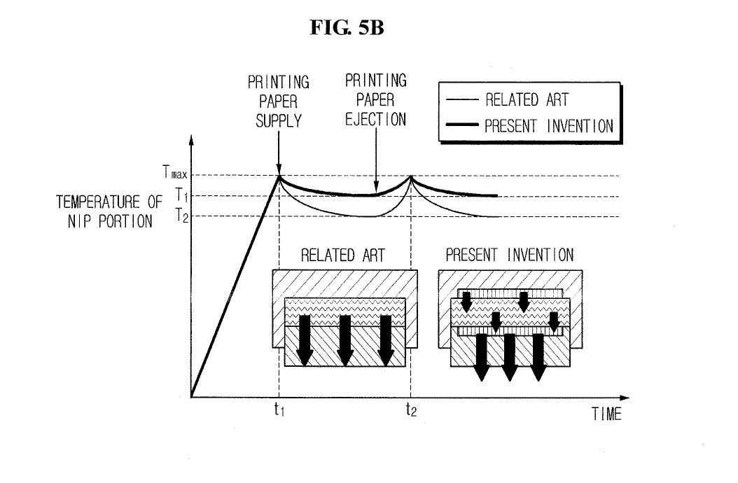

Referring to FIGS. 5A and 5B, a function and an operation of the phase changing portion 170 during a preheating process and a fusing process of the fusing device having the configuration which is fully described above, are described in detail below.

As described above, the phase changing portion 170 accumulates latent heat from heat of the heater 160, and provides the nip portion N with the accumulated latent heat.

In a preheating process, the heater 160 is supplied with a power source to generate heat. A portion of the generated heat is transmitted to the nip portion N of a forward area of the heater 160, and a residual portion is transmitted to the phase changing portion 170 provided on at least one surface of a front surface and/or a rear surface of the heater 160.

As illustrated in FIG. 5A, the material of the phase changing portion 170 is melted by heat transmitted from the heater 160, and accumulates latent heat in time t1 in which a temperature of the nip portion N reaches fusing temperature Tₘₐₓ.

In this instance, a melting point of the phase changing portion 170 may be higher than or equal to the fusing temperature Tₘₐₓ of the nip portion N, and a temperature of the phase changing portion 170 is established to reach a melting point when a temperature of the nip portion N reaches the fusing temperature.

Next, as illustrated in FIG. 5B, a printing paper having a relatively low temperature is supplied during a fusing process. When a printing paper is supplied and fusing is performed on the supplied printing paper after preheating is completed, a temperature of the nip portion N drops. Also, when the printing paper is ejected, a temperature rises again, and repeats a process of rising to a maximum temperature (time t₂) due to heat of the heater 160 again.

When the printing paper is supplied during the above process, the phase changing portion 170 is solidified, and the phase changing portion 170 provides the nip portion N with the latent heat accumulated by a phase change, thereby supplementing compensating for a temperature drop of the heater 160 having a small heat capacity.

Accordingly, as illustrated in FIG. 5B, a temperature of a fusing device according to related art drops to a temperature T₂ when a printing paper P is supplied, however, a temperature of a fusing device according to an exemplary embodiment of the present invention drops to temperature T₁. Therefore, the temperature drop of the nip portion N was significantly reduced, compared with the related art.

Similar to the description above, an exemplary embodiment of the present invention accumulates latent heat by the phase changing portion 170, and provides the nip portion N with the accumulated latent heat during the fusing process, thereby minimizing the temperature drop when the printing paper is supplied due to a small heat capacity of the heater 160.

Also, since residual heat is transmitted to the phase changing portion 170, and is accumulated as latent heat of the phase changing portion 170 when a temperature of the heater 160 is higher than or equal to a melting point of the phase changing portion 170, a temperature of the nip portion N may be controlled to be an optimum temperature for fusing. Specifically, a maximum temperature of the nip portion N may be easily controlled into a constant range.

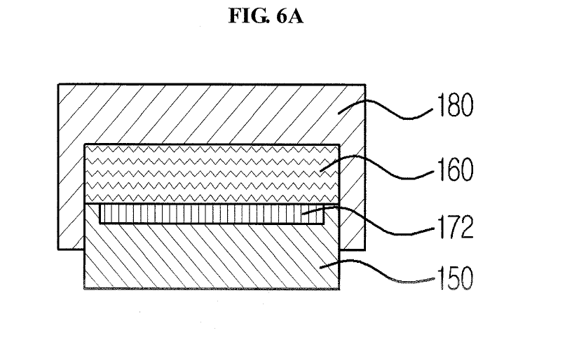

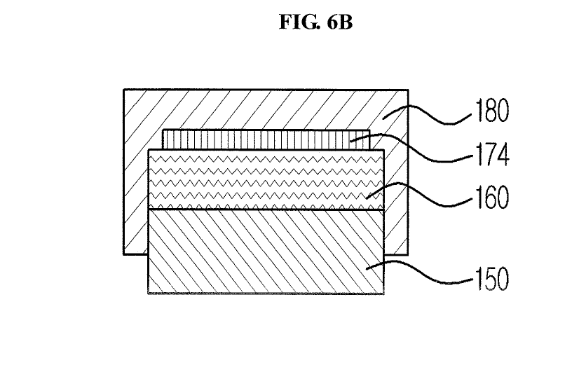

FIGS. 6A and 6B illustrate various examples of different locations of phase changing portions with respect to a heater and/or a nip portion according to an embodiment of the present general inventive concept.

Referring to FIG. 6A, a phase changing portion 172 is provided on at least one surface of a front surface and a rear surface of a heater 160. However, the present variation examples include forms in which the phase changing portion 172 includes a single layer.

The phase changing portion 172 is provided on a front surface of a heater 160, for example, between the heater 160 and a nip former 150 in FIG. 6A. Referring to FIG. 6A, a phase changing portion 174 is provided on a rear surface of a heater 160, for example, between the heater 160 and a supporter 180.

As describe above, locations in which the phase changing portions are provided may be variously changed. The phase changing portion may be provided on a lateral surface of the heater, or in a form covering an outside of the heater.

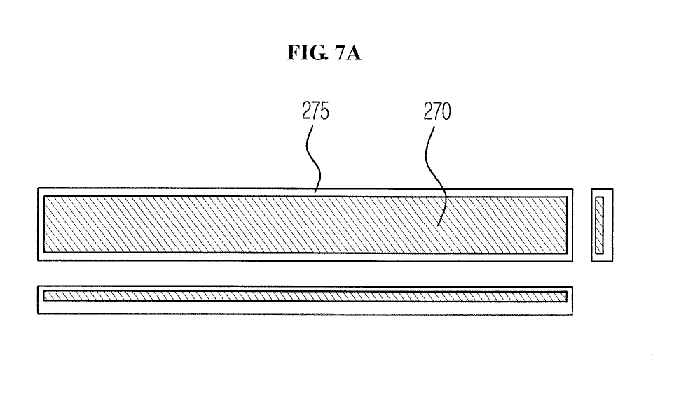

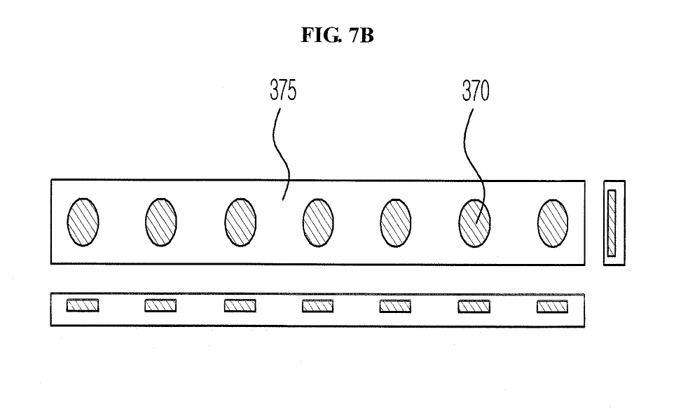

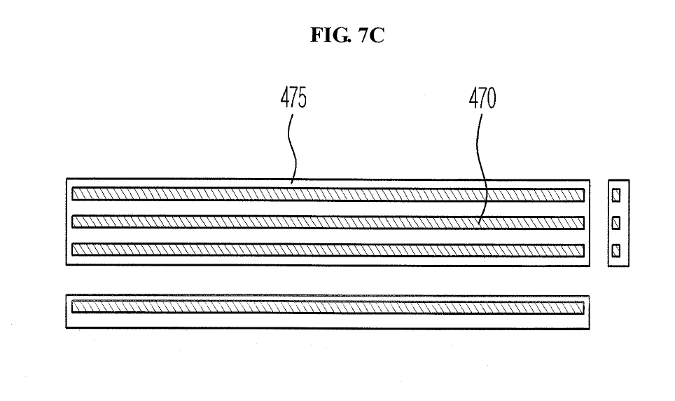

FIGS. 7A through 7C illustrate various examples of varying dispositions and forms of phase changing portions according to an embodiment of the present general inventive concept.

Phase changing portions 270, 370, and 470 may be disposed in various forms covering a width direction of a printing paper and a progressive direction of the printing paper.

FIG. 7A illustrates a form in which the phase changing portion 270 is provided in an inside of a housing 275 covering an entire surface of a width direction and a progressive direction of a printing paper.

FIGS. 7B and 7C illustrate forms in which the phase changing portions 370 and 470 are disposed in receiving grooves which are disposed on housings 375 and 475, respectively, at predetermined intervals according to either a width direction or a progressive direction of a printing paper. For example, FIG. 7B illustrates a form in which the phase changing portion 370 is disposed in circular grooves which are disposed in the housing 375 at predetermined intervals according to a width direction of a printing paper, and FIG. 7C illustrates a form in which the phase changing portion 470 is disposed in rectangular grooves which are separated in the housing 475 according to a progressive direction of a printing paper.

A fusing device and an image forming apparatus including the fusing device which have the above structure according to the present invention have the following effects.

First, there is an advantage that temperature drop due to printing paper supply can be minimized, an even temperature distribution during a fusing process can be maintained, and a printing quality can be improved, by providing a phase changing portion which accumulates latent heat from heat of a heater according to a phase change, and provides a nip portion with the accumulated latent heat.

Specifically, a fusing device and an image forming apparatus including the fusing device according to the present general inventive concept can significantly reduce a period of time of initial preheating, compared with a roller method of a related art, reduce a period of time of waiting, greatly reduce a temperature change amount due to a printing paper supply, and maintain a constant fusing temperature, thereby evenly fusing a toner particle to printing paper, and satisfying thermal stability.

In particular, a fusing device and an image forming apparatus including the fusing device according to the present general inventive concept can control a melting point appropriate for a fusing temperature by changing a composition ratio of materials included in the phase changing portion, thereby maintaining a rising temperature characteristic of reducing a period of time of initial preheating, and reducing temperature drop according to printing paper supply, more efficiently.

Second, there is an advantage that temperature drop can be minimized regardless of a printing load change, even when printing load increases due to high-speed printing and the like, thereby maintaining an even printing quality.

Third, there is an advantage that a temperature of a nip portion can be easily controlled to a temperature appropriate for fusing, since residual heat is transmitted to a phase changing portion when a temperature of a heater is higher than or equal to a melting point of the phase changing portion, and is accumulated to latent heat of the phase changing portion.

Although a few exemplary embodiments of the present general inventive concept have been shown and described, the present invention is not limited to the described exemplary embodiments. Instead, it would be appreciated by those skilled in the art that changes may be made to these exemplary embodiments without departing from the principles and spirit of the general inventive concept, the scope of which is defined by the claims and their equivalents.

What is claimed is:

1. A fusing device usable in an image forming apparatus which fuses a toner image formed on a printing paper, the fusing device comprising:
a pressure roller;
a fusing element to form a nip portion with the pressure roller;
a fusing belt which forms a nip portion where a printing paper is nipped with the pressure roller, and which rotates by a rotational force transmitted from the pressure roller;
a heater which is supplied with a power source to generate heat, and transmits at least a portion of the generated heat to the nip portion; and
a phase changing portion which includes a material having a phase varying according to a heating temperature range of the heater, accumulates latent heat from the heat of the heater, and provides the nip portion with the accumulated latent heat.

2. The fusing device of claim 1, wherein the phase changing portion adjoins the heater.

3. The fusing device of claim 1, wherein the phase changing portion is provided on at least one surface of a front surface and a rear surface of the heater.

4. The fusing device of claim 1, wherein the phase changing portion changes the phase between a solid phase and a liquid phase.

5. The fusing device of claim 1, wherein a melting point of the phase changing portion is equal to or higher than a fusing temperature of the nip portion.

6. The fusing device of claim 1, wherein the material of the phase changing portion is formed by mixing a plurality of materials having different melting points.

7. The fusing device of claim 6, wherein a melting point of the phase changing portion is controlled by changing a composition ratio of the plurality of materials.

8. The fusing device of claim 1, wherein the phase changing portion comprises at least one material of lead (Pb) and tin (Sn).

9. The fusing device of claim 1, wherein the phase changing portion is provided to cover an entire surface of a width direction and a progressive direction of the printing paper.

10. The fusing device of claim 1, wherein the phase changing portion is disposed in one or more receiving grooves which are disposed at predetermined intervals according to either a width direction or a progressive direction of the printing paper.

11. The fusing device of claim 1, further comprising:
a supporter which covers outside portions of the heater and the phase changing portion.

12. The fusing device of claim 1, further comprising:
a nip former provided between the heater and an inner circumferential surface of the fusing belt to form the nip portion on the fusing belt.

13. An image forming apparatus comprising:
a fusing device including a pressure roller, a fusing belt which forms a nip portion where a printing paper is nipped with the pressure roller and which rotates by a rotational force transmitted from the pressure roller, a heater which is supplied with a power source to generate heat, and transmits at least a portion of the generated heat to the nip portion, and a phase changing portion which includes a material having a phase varying according to a heating temperature range of the heater, accumulates latent heat from the heat of the heater, and provides the nip portion with the accumulated latent heat.

14. A fusing device usable in an image forming apparatus which fuses a toner image formed on a printing paper, the fusing device comprising:
a pressure roller;
a fusing element to form a nip portion with the pressure roller; and
a heater to generate heat, and to transmit the generate heat to the nip portion; and
a phase changing portion disposed adjacent to the heater to store a portion of the heat as latent heat, and to transmit the latent heat toward the nip portion.

15. The fusing device of claim 14, wherein the phase changing portion comprises a second heater to generate the stored portion of the heat as a second heat.

16. The fusing device of claim 14, wherein the phase changing portion comprises a material having a variable phase.

17. The fusing device of claim 14, wherein the phase changing portion comprises a phase varying according to a temperature of the heater.

18. The fusing device of claim 14, wherein the phase changing portion comprises a phase variable according to a temperature of the heat transmitted from the heater.

19. The fusing device of claim 14, wherein the phase changing portion comprises a plurality of phase changing portions disposed around the heater.

20. The fusing device of claim 19, wherein the plurality of phase changing portions are disposed in a direction parallel to a rotation axis of the fusing element.

21. The fusing device of claim 19, wherein the plurality of phase changing portions are disposed in a direction corresponding to a rotation direction of the fusing element.

22. The fusing device of claim 19, wherein the plurality of phase changing portions are spaced-apart from each other.

23. The fusing device of claim 14, wherein the phase changing portion comprises a first phase changing portion having a firs material having a first characteristic phase and a second phase changing portion having a second material having a second characteristic phase.

24. The fusing device of claim 23, wherein the first characteristic phase changes according to a first temperature of the heater, and the second characteristic phase changes according to a second temperature of the heater.

25. The fusing device of claim 14, wherein the phase changing portion is disposed in a direction parallel to a rotation axis of one of the fusing element and pressure roller.

26. The fusing device of claim 14, wherein the phase changing portion directly contacts the heater to receive the heat.

27. A fusing device usable in an image forming apparatus which fuses a toner image formed on a printing paper, the fusing device comprising:
a pressure roller;
a fusing element to form a nip portion with the pressure roller; and
a heater to generate heat, and to transmit the generate heat to the nip portion; and
a phase changing portion having a capacity greater than that of the pressure roller and the fusing element to store a portion of the heat as latent heat, and to transmit the latent heat toward the nip portion.
